(19) United States
(12) Patent Application Publication
(10) Pub. No.: US 2024/0200528 A1
(43) Pub. Date: Jun. 20, 2024

(54) UNDERWATER POWER STATION

(71) Applicant: INVESTSELSKABET JO APS, Varde (DK)

(72) Inventors: Bent HILLEKE, Nykøbing F (DK); Klaus WESTERGAARD SØRENSEN, Tjæreborg (DK)

(21) Appl. No.: 18/287,153

(22) PCT Filed: Feb. 16, 2022
(86) PCT No.: PCT/DK2022/050028

§ 371 Date: Oct. 16, 2023

(30) Foreign Application Priority Data
Feb. 17, 2021 (DK) PA 2021 00177

(51) Int. Cl. F03B 17/06

(52) U.S. Cl. CPC F03B 17/065; F05B 2210/11; F05B 2220/7068; F05B 2240/242; F05B 2240/30; F05B 2240/97

(57) ABSTRACT

A turbine for an underwater power station includes a rotor drum having blades that for each revolution are moved in and out of the drum, where the two end-edges of each of the blades are arranged slidingly in a corresponding stabilizing, linear, radially-oriented grooves in a rotational plate that is oriented perpendicular to the rotational axle. This way, the ends of the blades are supported when exposed to water flow while being outside the drum.

### FIELD OF THE INVENTION

The present invention relates to an underwater power station comprising a turbine with a rotor having blades that can be moved into and out of a rotational drum. In particular, the invention concerns a power station according to the preamble of claim 1.

### BACKGROUND OF THE INVENTION

For underwater power stations, a variety of water turbines principles exist, some of which use a rotor on an axle that is oriented transversely to the flow of water that drives the turbine. The rotor comprises blades that are periodically, once for each rotation, extended and retracted so as to have a larger area in a region where the flow of water is high and a smaller area for that part of the rotor that is moving in the opposite direction against the water stream.

Dutch patent application NL1040434 discloses a principle in which the rotor comprises a cylindrical drum having multiple radially oriented slots, extending in parallel along the drum, and each of which is housing a blade. The blades are mounted slidingly in the slots for periodically, once for each rotation, being pushed radially out of the slots and again retracted into the slots so as to provide blades outside the drum mainly on only one side of the drum. This principle is simple but has turned out to require very stiff blades, as otherwise, the blades are deformed by the flowing water to a degree that makes sliding of the blades back into the slots difficult. Although, stiff blades are strong and solid, which is good for a long-lasting mechanical stability, such stiff blades are typically heavy and accordingly expensive in production and transportation, which is disadvantageous.

European patent application EP1478847 and, equivalently, international patent application WO03/029646 disclose an underwater power station comprising a turbine with a rotor on a horizontal rotational axle. The rotor comprises a shaft that carries a number of flat double-sheets that function as envelops, projecting outwards from the shaft. Each of these envelops houses a blade that is mounted displaceable in between the sheets for being pushed radially out of the envelop and retracted again for each revolution of the rotor. During rotation of the rotor, the blades are periodically, once for each rotation, pushed partially out of the envelop for increasing the active area of the blade on one side of the rotor where the main water flow is and then retracted again. As compared to the drum of NL 1040434, the principle of EP1478847 takes into account a possible flexibility of the blades because flexible envelops adjust to the flexible blade and allow proper extension and retraction of the blades relatively to the envelops. Although, the flexibility of both blade and envelop is an advantage for smooth mechanical extension and retraction, it reduces the efficacy of the turbine because the blades are deformed by the water, and implies an increased risk for material fatigue with time or even breakage, which is disadvantageous and not desired.

European patent application EP1079104 discloses a combination of these two principles of NL1040434 and EP 1478847 in that double-sheet envelops are provided in radial slots in a drum and blades are provided slidingly in the envelops. During rotation, not only are the blades pushed out of the envelops, but the envelops are also pushed out of the drum. This is useful in that for each rotation, the area of the envelop is added to the area and the blade, which increases efficiency of the rotor. However, due to the envelops sliding in and out of the slots in the drum while accommodating the blade, the blades as well as the envelops have to be relatively thin with corresponding high degree of flexibility and correspondingly high degree of deformation when in operation. Correspondingly, both problem that were discussed above are encountered with this system, namely the deformation of the envelop being disadvantageous during retraction into the drum and the problem with general deformation of thin blades. As already mentioned, deformation is a general problem for not only for the efficiency of the turbine but also with respect to long-term stability. In order to increase stability of the blades, the blades in EP1079104 are at their front corners connected with rollers in a lateral rail that also defines the extension and retraction of the blades when the rollers follow the curved structure of the rail. Although, the rollers increase stability at the outermost corners of the blades, it only partially solves the problem of instability due to the force from the water flow due to the fact that the suspension is only at the outermost corners.

Accordingly, there is still potential and general need for improvements of mechanical stability of such turbines, in particular, because, on the one hand, large flexibility and deformation is not desired and, on the other hand, also heavy or expensive materials for stiffness are disadvantageous.

### DESCRIPTION/SUMMARY OF THE INVENTION

It is therefore an objective of the invention to provide an improvement in the art. In particular, it is an objective to provide a rotor system with blades that can be made of a low-cost, light-weight material without compromising necessary stiffness and long-term stability. This objective and further advantages are achieved with an underwater power station and a turbine therefore as described below and in the claims.

The underwater power station according to the invention comprises a turbine, the turbine comprising a base and a rotor that is rotationally supported by the base and configured for being rotationally driven by the force of water flowing through the turbine: wherein the rotor comprises a drum suspended on a rotation axle: wherein the rotor comprises a plurality of blades, wherein each of the blades is delimited by an rear edge, an front edge, and two end-edges, one at either end of the blade: wherein the drum comprises a longitudinal axis and one slot for each one of the blades, wherein each one of the blades is suspended slidingly in such one of the slots and arranged for sliding into this slot during a first part of revolution of the rotor and out of this slot during a second part of revolution of the rotor: wherein the drum is arranged between two rotational flanges and fixed to the rotational flanges for rotating together: wherein the rotational flanges extend radially outwards from the drum, wherein the turbine comprises a stationary support arranged adjacent to at least one of the rotational flanges, wherein a plurality of permanent magnets are attached to at least one of the rotational lateral flanges, wherein the permanent magnets are distributed along a first circular path corresponding to a circle having a center coinciding with the longitudinal axis of the drum, wherein a plurality of coils are attached to the support, wherein the coils are distributed along a second circular path of the same size as the first circular path and corresponding to a circle having a center coinciding with the longitudinal axis of the drum, wherein the coils are electrically connected to wires arranged to conduct electric current generated by induction upon rotation of the rotor.

Hereby, it is possible to harvest energy in form of induced electricity without transferring a large torque through an axle extending in extension of the rotor. Accordingly, the mechanical strength of the construction can be reduced compared to the prior art underwater power stations transferring a large torque through an axle extending in extension of the rotor. Hereby, it is possible to scale up the construction and still be able of putting into practise a reliable and robust turbine that can withstand the forces applied to it under operation.

In one embodiment, a plurality of permanent magnets is attached to both rotational lateral flanges, wherein the permanent magnets are distributed along a circular path corresponding to a circle having a center coinciding with the longitudinal axis of the drum, wherein a plurality of coils are attached to the supports adjacent to each of the rotational lateral flanges. Hereby, it is possible to maximize the power generating capacity of the turbine.

In one embodiment, the permanent magnets are distributed along the circular path(s). Hereby, the power generating capacity of the turbine can be optimized.

In one embodiment, the coils are distributed along the circular path(s). Hereby, the power generating capacity of the turbine can be optimized.

In one embodiment, the permanent magnets are integrated in rotational lateral flange(s) made of plastic, wherein the permanent magnets are enclosed by plastic. Enclosing (surrounding) the permanent magnets with plastic, makes it possible to provide a practical, robust and reliable turbine.

In one embodiment, the coils are integrated in a support made of plastic, wherein the coils are enclosed by plastic. Enclosing (surrounding) the coils with plastic, makes it possible to provide a practical, robust and reliable turbine.

In one embodiment, the permanent magnets and the coils have the same cross-sectional area.

In short, the turbine for an underwater power station comprises a rotor drum having blades that for each revolution are moved in and out of the drum, where the two opposite end-edges of each of the blades are arranged slidingly in a corresponding stabilizing, linear, radially-oriented grooves in a rotational plate that is oriented perpendicular to the rotational axle. This way, the ends of the blades are supported when exposed to water flow while being outside the drum

As a further measure, the blades are only pushed partially out of the rigid drum slot so that the blades are supported, firstly, by the slot in the drum and so prevented from deformation of one long side and, secondly, supported by the radial grooves at either end of the blade and prevented from deformation of the edges at the two opposite ends of the blades. Due to the stabilizing supports of the blades along three of the edges, a high degree of stiffness and stability is obtained without the blade requiring a high degree of stiffness in itself.

In more detail, the turbine of the underwater power station comprises a base and a rotor that is rotationally supported by the base and configured for being rotationally driven by the force of water flowing through the turbine. The rotor comprises a drum suspended on a rotation axle. For highest efficiency in operation, the axle is provided lateral to a water flow. It is optionally oriented horizontally, inclined or vertically relatively to the seabed.

The rotor further comprises a plurality of blades. Each of the blades is elongate with a longitudinal direction and a shorter transverse direction and delimited by a rear edge and a front edge, which form longitudinal edges, and two end-edges, one at either end of the blade to form lateral edges. Typically, the blades are rectangular with straight edges.

The drum comprises one slot for each one of the blades, wherein each one of the blades is suspended slidingly in such one of the slots and arranged for sliding into this slot during a first part of each revolution of the rotor and out of this slot during a second part of each revolution of the rotor.

The drum is arranged between two rotational flanges and fixed to the rotational flanges for rotating together. Each of the rotational flanges extends radially outwards from the drum and comprises a plurality of radial grooves, of which each one is aligned with only one of the slots and extends radially outward from the corresponding slot. The pair of end-edges of each one of the blades is suspended slidingly in a corresponding pair of parallel radial grooves, one in each of the rotational flanges, for being supported in the grooves of the two rotational flanges and stabilized by the grooves in both rotational flanges, at least when moving radially outside the slot.

Due to the fact that the end-edges are suspended in the grooves, the blades are stabilized against twist from forces of the water and also stabilized against deformation by turbu-lences. This is a great advantage relatively to the aforementioned prior art.

Typically, the end-edges of the blades are suspended inside the grooves along the entire length of the end-edge.

Optionally, the grooves are not only provided in the rotational flanges at a location outside the drum but continue inside the drum such that the blades are suspended inside grooves also when pulled into the drum. This way, the grooves rather than the slot de-termine and stabilize the movement of the blades outwards and inwards. For easy and smooth movement, the blades may be provided with rollers that are rolling against the inner surface of the slots. Alternatively, the grooves and/or the blades have a low friction material at the interface between the blade and the groove.

Advantageously, the rotor is configured for moving the blade only partially out of the slot so that the rear edge of the blade remains inside the slot of the drum. This way, the blade is stabilized by the drum along its rear edge, and thus along its longitude, when the blade extends outwards from the slot. Together with the stabilizing suspension of the end-edges in the grooves, the blade is stabilized along three of its edges, which leads to a high mechanical stability of the blade, even when fully extended out of the slot, which reduces mechanical load on the blade and the suspending system as well as long term fatigue of the material. Further, the minimized deformation of the blade by the water flow maximized rotor efficiency

In some embodiments, the movement of the blades in and out of the slots is done by hydraulic or pneumatic actuators.

However, a simpler mechanism is achieved in the following embodiment where the turbine comprises two end flanges that are stationary relatively to the base and arranged at opposite ends of the drum. Each of the stationary end flanges comprises a stationary closed-curved blade guide arranged circumferential around the axle.

For example, the blade guide is a curved groove, aperture, or rail.

A connection member, for example a slider or roller, of each of the blades is movably connected to the blade guide in order for the connection member to be guided along the blade guide during rotation of the rotor. The blade guide is closer to the axle in a first part of the blade guide than in a second part of the blade guide. In operation, during rotation of the rotor, the connection member is periodically during each revolution of the rotor retracted together with the corresponding blade towards the axle, which causes the blade to move into the slot of the drum, and subsequently moved together with the corresponding blade away from the axle, which causes the blade to move out of the slot of the drum, for example partially out of the slot.

The blade guide has a first radius of curvature at a location where the blade guide is closest to the axle and a second radius of curvature at another location where the blade guide is farthest from the axle. In contrast to the aforementioned prior art system of EP1478847, the first radius of curvature is smaller than the second radius of curvature. Accordingly, the shift from extension to retraction of the blades is smoother and less aggressive than in the system of EP1478847 and puts less load on the connection member, which is advantageous over the described prior art, as it minimizes the risk for long term fatigue and breakage.

For mechanical stability, the blade guide is provided not closer to the axle than a minimum distance D, wherein D is in the range of 5-50%, for example 10-30%, of a height H of the blade, when measured along the blade in radial direction. In comparison to the system of EP1478847, where the groove is right at the shaft, the combination of end flange and groove in the herein described system has a higher mechanical stability and stiffness, which in turn reduces the risk for long term fatigue and breakage.

Advantageously, the connection member is provided at the end-edge with a distance d from the rear edge of the blade, wherein d is in the range of 50-96% of D.

Optionally, the rotor is configured for moving the connection member radially to a location outside the drum when the corresponding blade is moved maximum out of the slot, while the rear edge of the blade remains in the slot of the drum. This has the advantage that the extension of the blade is optimized in this construction while still providing the stability of the rear edge being suspended inside the slot.

For example, the connection member is a projection extending from the end-edge of the blade and into the blade guide. Optionally, the projection is provided as or with a slider or comprises a roller.

As it appears from the arguments above, the turbine is more rigid than the prior art, which is achieved by simple means without requiring heavy rigid material and without requiring high-cost light-weight stiff material.

In order for the blades to slide in and out of the slots in the drum, they are advantageously made in a material with low friction, in particular low friction plastics, such as fluoropolymers, including polytetrafluoroethylene, PTFE, also called Teflon. Despite low friction, the material has to be durable in underwater conditions. The blade material can be slightly bendable/flexible, as the stability is given by the grooves. Flexibility is advantageous for causing less injury for underwater animals colliding with the rotor. Other examples of such materials include thermoplastic polymers, including polyole-fins.

In contrast to WO03/029646, the blades are not interconnected in pairs with interconnecting bars. In particular, being free of such interconnecting bars reduces weight and allows a better customized design of the blade guide, as each blade can move in and out independently of the other blades. It also allows an uneven number of blades being used.

### SHORT DESCRIPTION OF THE DRAWINGS

The invention will be explained in more detail with reference to the drawing, where

FIG. 1 is a principle sketch of an underwater power station:

FIG. 2 is a perspective view of a turbine for an underwater power station:

FIG. 3A illustrates a front view of a turbine for an underwater power station:

FIG. 3B illustrates a principle sketch from an end view of the turbine:

FIG. 3C illustrates an enlarged portion of the turbine of FIG.: 3A:

FIG. 3D illustrates a possible design of the blade guide:

FIG. 4 is a semi-transparent end view:

FIG. 5 illustrates a principle of water flow through the turbine:

FIG. 6 shows a perspective view of a turbine for an underwater power station according to the invention:

FIG. 7 shows a cross-sectional sideview of the turbine shown in FIG. 6:

FIG. 8 shows a cross-sectional sideview of the turbine shown in FIG. 6 and FIG. 7 and

FIG. 9 shows a close-up cross-sectional view of a portion of a rotational lateral flange and an adjacent support of a turbine as the one shown in FIG. 6 and FIG. 7.

### DETAILED DESCRIPTION/PREFERRED EMBODIMENT

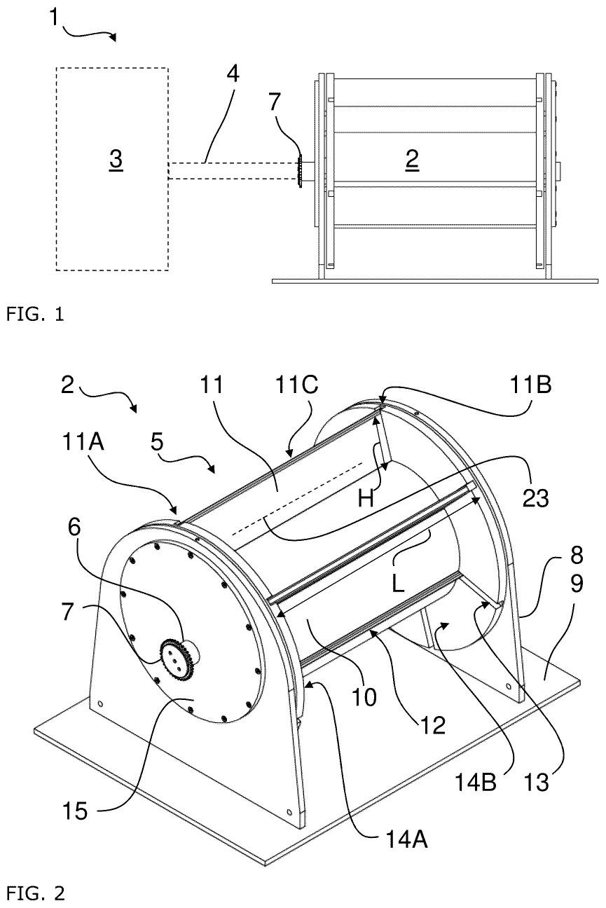

FIG. 1 illustrates a principle of an underwater power station 1. It comprises a turbine 2 driven by flow of water passing through the turbine 2. The turbine 2 is connected to an electrical generator 3 through a rotational transmission shaft 4 for transmitting rotational momentum from the turbine 2 to the generator 3. In the generator 3, the rotational energy from the transmission shaft 4 is converted to electrical power. Electrical current is then extracted by cables to the location of use for the electrical power. It is important to underline that the generator 3 can be placed in various positions. In one embodiment, the generator 3 is arranged at the base 9 (see FIG. 2). In a preferred embodiment, the generator 3 is mechanically connected to the rotational transmission shaft 4 by means of a connection assembly (not shown) that allows the generator 3 to be connected to and disconnected from the rotational transmission shaft 4. Hereby, it is possible to service or replace the generator 3 while the rotor of the turbine 2 is rotating. It is a major advantage that the underwater power station 1 comprises a connection assembly that eliminates the need for stopping the rotor of the turbine 2 during service or replacement of the underwater power station 1.

FIG. 2 is a perspective view of the turbine 2. The turbine 2 comprises a rotor 5 supported on an axle 6, an axle flange 7 of which is connectable to the transmission shaft 4, as illustrated in FIG. 1.

The axle 6 and the rotor 5 are journaled in a support 8 on a base 9. For example, the base 9 is positioned on the bottom of a seabed or on a bottom-based underwater structure that is elevated relatively to the seabed. The latter can be useful, if the water flow is stronger and/or faster at a distance above the seabed. Alternatively, the base 9 is provided on a floating structure. Typically, the turbine 2 is stationary relatively to the seabed. Important for the functioning of the turbine 2 is that water flows through the turbine 2, which is typically achieved by exploiting natural flow of water.

The axle 6 is exemplified in horizontal orientation with the rotational axis of the rotor 5 being horizontal. However, the orientation is not necessarily horizontal, as the turbine 2 can function in other orientations, as long as the axle 6 is transverse or largely transverse to the water flow for maximum efficiency.

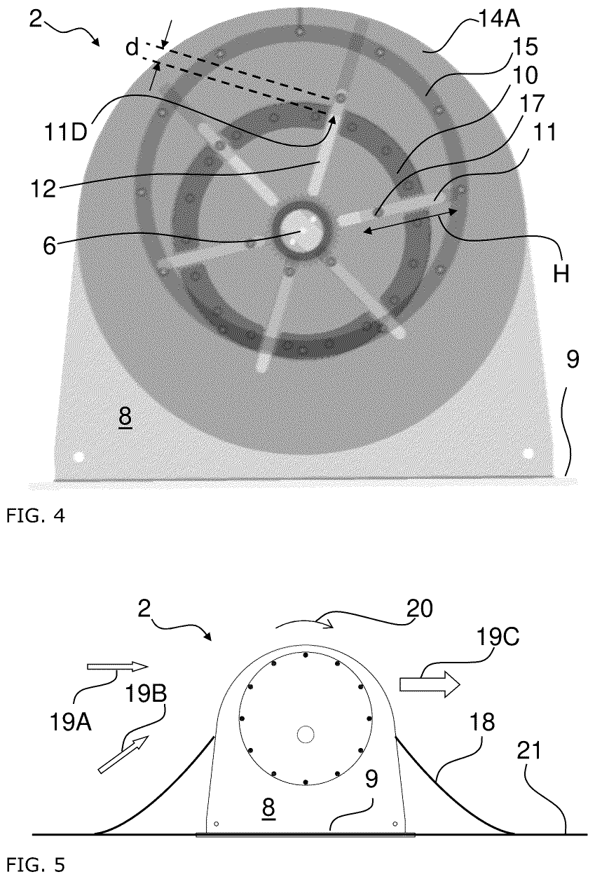

The rotor 2 comprises a drum 10 carrying a plurality of identical blades 11. Each blade 11 is delimited by a rear edge (shown as 11D in FIG. 4), which is inside the drum 10 at all times for stabilizing reasons, a front edge 11C pointing in a radial direction away from the axle 6 and two end-edges 11A, 11B at opposite ends of the blade 11. As exemplified, the rear edge 11D, the front edge 11C, and the two end-edges 11A, 11B form a rectangle oriented with its elongate direction 23 in parallel with the axle 6. Each blade 11 has a length L measured in parallel to the axle 6 and a height H measured laterally in a radial direction.

In FIG. 2, six blades 11 are illustrated, but this number is not delimiting, as more than six blades 11 can be used. Typically, the number of blades is 5-12.

Each of these blades 11 is mounted radially displaceable in a slot 12 in the rotational drum 10 so as to be retractable into the slot 12 of the drum 10. During rotation of the rotor 5 and, accordingly during rotation of the drum, the blade 11 is periodically retracted into the drum 10 where it stays during first part of each revolution of the rotor 5 and partially extended out of the drum 10 where it is accessible for force from water flow for another part of the revolution. This is similar to the function of rotors as per the prior art mentioned in the introduction. When the blades 11 are extended for projecting radially outwards, the water flow acts on the blades 11, which is not the case during the first part of the revolution, where the blades 11 are inside the drum 10. In FIG. 2, the first part of the revolution is in the region between the axle 6 and the base 9.

Notice that the blades 11 are not moved entirely out of the drum by a distance corresponding to their full height H, but a minor portion, for example in the range of 2-15% of H, typically 2-10%, is maintained inside the drum 10 for stabilizing reasons. When the rear edge 11D of the blade 11 resides inside the drum 10, it is stabilized in longitudinal direction 23 against deformation by the water flow.

During a revolution, the distance between the center of the axle 6 and the front edge 11C of the blade 11 varies between the radius of the drum and a maximum radius, which is less than two times the radius of the drum because the rear edge 11D of the blade 11 has to remain inside the drum 10. For example, if the difference between the radius of the drum 10 and the radius of the axle 6 is X, so that X defines the distance from the axle 6 to the rim of the drum 10, the blades 11 are pushed out from the drum less than X, so that the rear edge 11C is still inside the drum.

Further, in contrast to the described prior art, the elongate blades 11 are additionally stabilized at their ends by having the edges 11A, 11B at their opposite ends supported slidingly in radial grooves 13. The radial grooves 13 are provided in two rotational lateral flanges 14A, 14B, as part of the rotor 5. The radial grooves 13 define the movement of the blades 11 in the radial direction. The lateral flanges 14A, 14B extend radially outwards from the drum 10. In the exemplified rotor 5, the two lateral flanges 14A, 14B are provided at opposite ends of the drum 10. When a blade 11 is moved out of its slot 12 in the drum 10, that part of each of the edges 11A, 11B which is outside the drum 10 is fully supported in the two oppositely positioned corresponding grooves 13, which results in a high degree of stability of the blade 11, higher that in the systems according to the prior art described in the introduction.

As the blades 11 are only pushed partially out of the rigid drum slot 12, the blades are supported by the slot 12 in the drum and so prevented from deformation along the rear edge. Furthermore, the edges 11A, 11B at opposite ends of the blades 11 are supported by the radial grooves 13 and, thus, also prevented from deformation for that part that is inside the groove. Due to the stabilizing support of the blade 11 along three of its edges, a high degree of stiffness and stability is obtained without the blade 11 material itself requiring a high degree of stiffness.

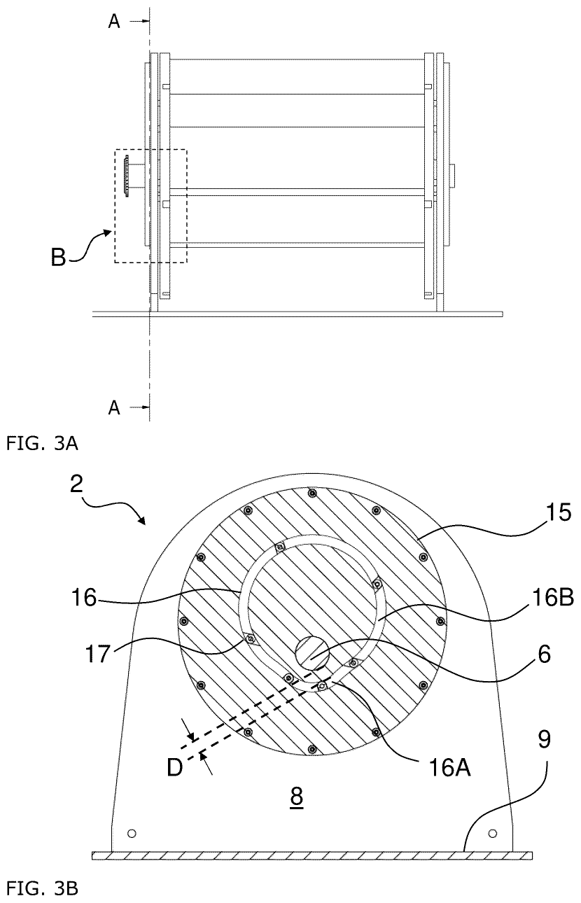

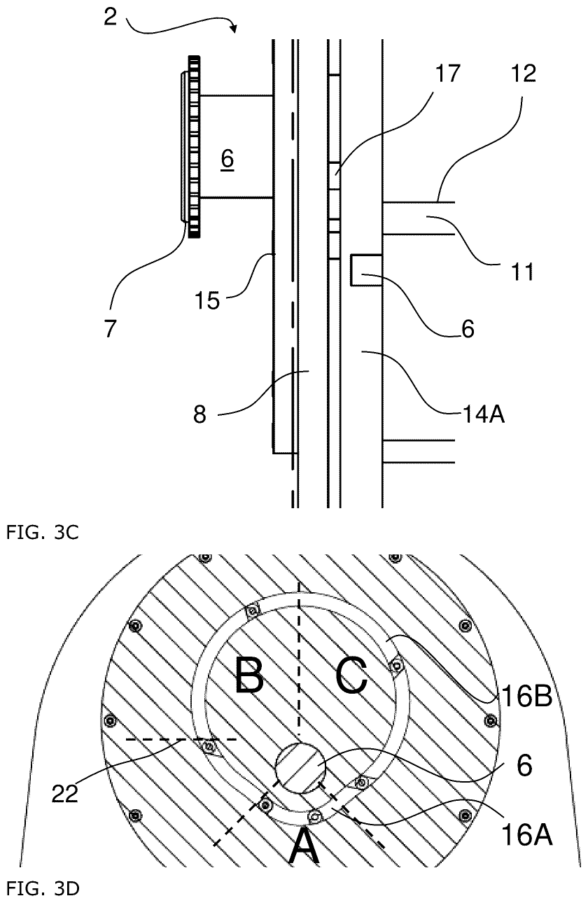

In some embodiments, the displacement of the blades 11 is achieved by a pneumatic or hydraulic actuators. However, a simple mechanical displacement mechanism linked to the rotation of the rotor 5 as forced by the water flow is described in relation to FIG. 3.

FIG. 3A illustrates a side view of the turbine 2, the view being transverse to the axle and facing the rotor in a direction in which the water should flow for highest efficiency. Illustrated in FIG. 3A is a vertical cross-sectional view A-A, which is illustrated in FIG. 3B, as well as a rectangular part B, which is shown in greater detail in FIG. 3C.

FIG. 3B shows the cross-section A-A through the stationary end flange 15. Each end flange 15 comprises a circumferential blade guide 16 along a closed circumferential curve, along which blade projections 17 move. As illustrated, one single projection 17 extends from each end-edge 11A, 11B of the blade 11.

The blade guide 16 is illustrated as a circumferential groove inside which the projections move, for example slide or roll with rollers. However, the blade guide 16 could also be a rail on which projections, optionally with rollers, move.

With reference to FIG. 3B in combination with FIG. 3C, the blade projections 17 are fastened to the blades 11 or are integral with the blades 11 and extend from the end-edges 11A, 11B of the blades 11 into the blade guide 16. The projections 17 are extending from opposite ends of the blade 11. The two blade guides 16, one in either of the two end flanges 15 at opposite ends of the drum 10, are congruent, and the peripheral projections 17 of the blades 11 will automatically follow the curve of the blade guides 16 in the stationary end flanges 15 when the rotor 5 is rotating. The blade guide 16 is closer to the axle 6 in that part of the end flange 15 that is closer to the base 9. When the rotor 5 rotates, the projections 17 of the blades 11 are periodically for each rotation of the rotor 5 pulled towards the axle 6 and into the drum 10 when the blades 11 are moving towards the base 9 and pushed radially out of the drum 10 in a direction away from the axle 6 when the blades 11 are moving away from the base 9.

For mechanical stability of the blade guide 16 in the end flange 15, it is provided at a minimum distance D from the axle 6, as illustrated in FIG. 3B. Examples for the distance D is in the range of 5-50% of the height H of the blade 11 in a radial direction, optionally 10-30%.

With reference to FIG. 3D, a first guide part 16A of the blade guide 16, which is closest to the base 9, follows a circular curve, which implies that the distance of the blade 10 to the axle 6 is constant for the blade 11 when its projection 17 is moving in this circular curve in the first guide part 16A. When the projection 17 during revolution of the rotor 2 has passed this first guide part 16A and continues along the second guide part 16B, which is that portion of the blade guide 16 where the distance of the blade guide 16 to the axle 6 increases, the blade 11 is moved out of the drum 10, before it is finally moved back into the drum 10 during the portion of the revolution where the blade 11 rotates towards the base 9.

In the exemplified embodiment of FIG. 3B, the first part extends over and angle A of the revolution, and the second part 16B over the remaining angles B and C. For completeness, it is pointed out that A+B+C=360 degrees. The sum of B+C is more than 180 degrees, and typically more than 240 degrees.

The first guide part 16A, where the blade is fully retracted into the drum, extends over an angular span of A, which in FIG. 3D is exemplified to 90 degrees of a revolution, but which could be more or less than that, although, it is typically within the angular range of 70-120 degrees. Over the angular span of B, which is exemplified to 135 degrees, the blade is rotating away from the base and moving radially away from the axle 6, and in the angular span C, which is exemplified to 135 degrees, the blade 11 is pulled back towards the axle 6. For completeness, it is pointed out that A+B+C=360 degrees.

In the illustrated embodiment, the second part 16B comprises a circular portion, which is that portion that is above the stippled horizontal line 22. This circular portion is span-ning over more than 180 degrees, implying a smooth extension and retraction of the blades 11. It is pointed out, in comparison, that the guide path in the aforementioned prior art WO03/029646 and EP1478847 is not following a circular curve but is sharply oval when the blades are mostly extended from the axle, resulting in a relatively fast switch from extension to retraction, thus, being by far less smooth. However, the smoother path as illustrated in FIG. 3D with the circular upper portion above the line 22 yields a higher efficacy, as the blades remain extended for a longer time in the water outside the drum 10. In further comparison with WO03/029646 and EP1478847, it is observed that the smallest radius of curvature of the blade guide 16 is in the first part 16A closest to the axle 6, whereas in EP1478847 (see FIG. 3 in EP1478847), the smallest radius of curvature is in that part of the circumferential guide that is most distal to the axle. Accordingly, the shift from extension to retraction of the blades 11 is more aggressive in the system of EP1478847 and puts more load on the projections 17 than in the embodiment shown in FIG. 3D. Accordingly, the exemplified embodiment in FIG. 3D is advantageous over the described prior art.

FIG. 4 is a semitransparent drawing that illustrates the principle in greater detail. During rotation of the drum 10, the blade 11 is pulled into the drum 10 during its rotation towards the base 9 and stays inside the drum when the blade 11 is nearest to the base 9, and the blade is pushed out of the drum 10 when the blade 11 is rotating away from the base 9 and stays outside the drum when located remote from the base 9, due to the projections 17 following the curve of the blade guide 16, as explained in relation to FIG. 3. It is observed that the blades 11 are not pushed entirely out of the drum 10 but only partially out of the drum 10 to an extent where the rear edge 11D still remains inside the slot 12. Thus, the rear edge 11D is stabilized inside the slot 12 at all times during the revolution of the drum 10.

As exemplified, in order to optimize space and efficiency, the blades 11 are retracted close to the axle 6, so that the diameter of the drum 10 is minimized, which is advantageous for high efficiency of the rotor 5. However, this requires that the projection 17 is not provided flush with the rear edge 11D but at a distance d from the rear edge 11D. The distance d is larger than zero but smaller than the distance D (see FIG. 3B) in order for the rear edge 11D of the blade not to collide with the axle 6 when retracted. For example, d is in the range of 50%-95% of D, but advantageously d is only slightly smaller than D, for example in the range of 70-95% of D. This implies, as illustrated in FIG. 4, that the projection 17 is located outside the outer periphery of the drum 10 while the rear edge 11D is still inside the drum 10 and supported in the slot 12 when the blade 11 is moved maximally away from the axle 6.

In contrast to the prior art, the blades 11 are not interconnected two-by-two with interconnecting bars, as in WO03/029646. In particular, the avoidance of such interconnecting bars reduces weight and allows a better customized design of the blade guide, as each blade can move in and out independently of the other blades.

FIG. 5 illustrates a practical embodiment in which the turbine 2 is positioned with its base 9 on a seabed 21. Flow guides 18 deflect water from the seabed 21 upwards towards the upper part of the turbine 2 so that not only the horizontally flowing water 19A at the level of the upper part of the turbine 2 pushes the blades 11 but also the deflected bottom water 19B, adding up to an increased flow of the water 19C through the turbine 2, causing efficient rotation 20 of the rotor 5.

In the presented examples, the base 9 and axle 6 have been illustrated horizontally, which, however, is not necessary. The axle 6 may have a different orientation, for example inclined or even vertical. In vertical orientation, the bases 9 of two turbines 2 can potentially be placed back-to-back so that two turbines run in parallel. Optionally, numerous turbines 2 are arranged in extension of each other as a row of turbine modules with parallel axles 6 in extension of each other. Optionally, the axels are connected to each other, for example at the axle flanges 7, to form a multiple axle arrangement with numerous rotors 2 in extension of each other and connected to a single generator 3.

Another option is a stack of such turbine modules, one above the other with parallel axles being spaces laterally. Providing the turbines 2 as modules allows a variety of flexible modular configurations.

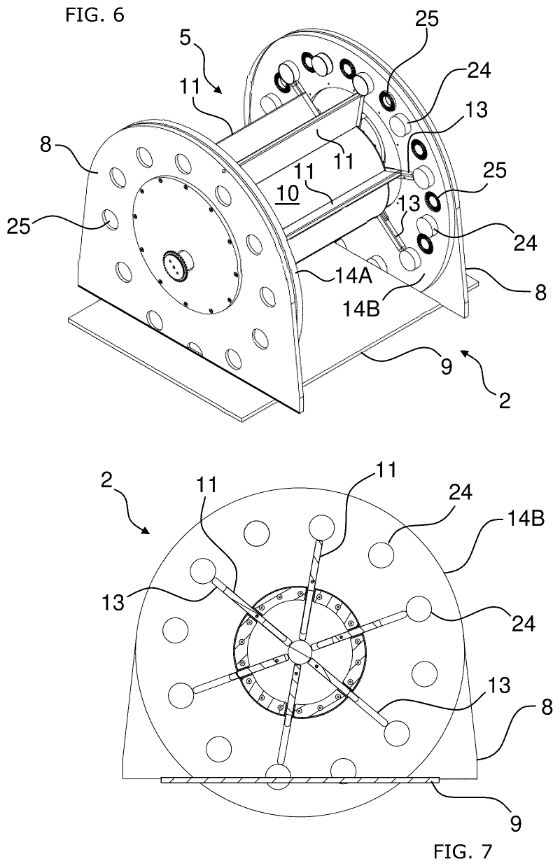

FIG. 6 illustrates an embodiment of a turbine 2 having a base 9 that is positioned on a seabed. The turbine 2 basically corresponds to the one shown in and explained with reference to FIG. 2. The axle may be omitted since energy is harvested without using an axle. The turbine 2 comprises a rotatably mounted rotor 5. The rotor 5 comprises a cylindrical drum 10. The rotor 5 is provided with a plurality of blades 11 protruding from the drum 10. The blades 11 are slidably mounted as shown in and explained with reference to FIG. 2 and FIG. 4.

The blades 11 are guided by axially extending slots 13 provided in the rotational lateral flange 14B which is transparent in FIG. 6. The motion of the blades 11 can be controlled by using the axially extending slots 13.

A plurality of permanent magnets 24 are attached to the rotational lateral flange 14B. The permanent magnets 24 are distributed along a circular path. The circular path corresponds to a circle having a center coinciding with the longitudinal axis of the drum 10. A plurality of coils 25 are attached to the support 8. The coils 25 are distributed along a circular path corresponding to a circle having a center coinciding with the longitudinal axis of the drum 10. Accordingly, upon rotation of the rotational lateral flange 14B, the permanent magnets 24 are moved along the path, along which the coils 25 are placed. Accordingly, current is induced in the coils according to Faraday's law. The electric power generated by induction, can be harvested.

In a preferred embodiment, the arrangement with permanent magnets 24 and coils 25 are provided in both sides of the turbine 2. Accordingly, a plurality of permanent magnets 24 are attached to the rotational lateral flange 14A and the permanent magnets 24 are distributed along a circular path corresponding to a circle having a center coinciding with the longitudinal axis of the drum 10. A plurality of coils 25 are attached to the support 8 adjacent to the rotational lateral flange 14A.

In one embodiment, the permanent magnets 24 are integrated in the rotational lateral flange 14B. In one embodiment, the rotational lateral flange 14B is made in plastic into which the permanent magnets 24 are integrated. It may be an advantage to enclose the permanent magnets 24 by plastic because the plastic hereby can seal and protect the permanent magnets 24 against water. In one embodiment, the the permanent magnets 24 are evenly distributed.

In one embodiment, the coils 25 are integrated in the support 8. In one embodiment, the support 8 is made in plastic into which the coils 25 are integrated. It may be an advantage to enclose the coils 25 by plastic because the plastic hereby can seal and protect the coils 25 against water. In one embodiment, the the coils 25 are evenly distributed.

FIG. 7 illustrates a cross-sectional sideview of the turbine 2 shown in FIG. 6. It can be seen that twelve permanent magnets 24 are integrated in the rotational lateral flange 14B. It can be seen that the blades 11 are slidably arranged in and guided by axially extending slots 13 provided in the rotational lateral flange 14B. The turbine 2 has a base 9.

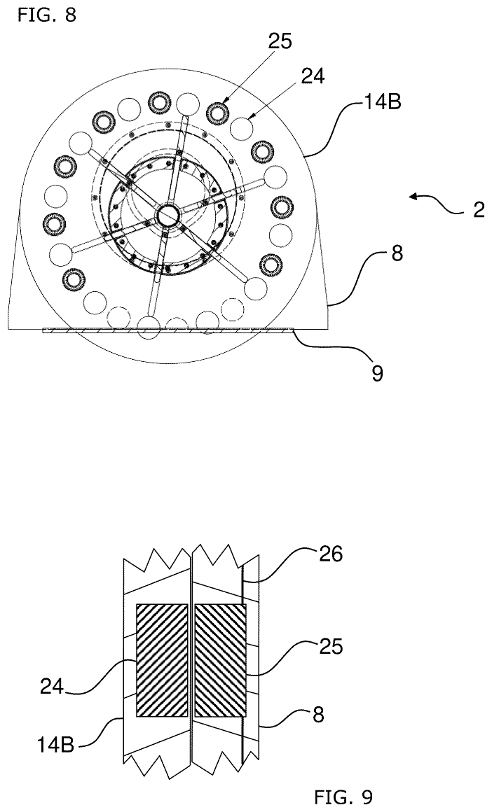

FIG. 8 illustrates another cross-sectional sideview of the turbine 2 shown in FIG. 6 and FIG. 7. It can be seen that twelve permanent magnets 24 are integrated in the rotational lateral flange 14B. A similar number of coils 25 are integrated in the support 8. The turbine 2 has a base 9.

FIG. 9 illustrates a close-up cross-sectional view of a portion of a rotational lateral flange 14B and an adjacent support 8 of a turbine 2 as the one shown in FIG. 6 and FIG. 7. It can be seen that a permanent magnet 24 is integrated in the rotational lateral flange 14B and that as coil 25 is integrated in the support 8. The rotational lateral flange 14B and the adjacent support 8 are arranged close to each other.

In a preferred embodiment, the permanent magnet 24 is integrated in a rotational lateral flange 14B made of plastic, wherein the permanent magnet 24 is enclosed by plastic. In a preferred embodiment, the coil 8 is integrated in a support 8 made of plastic, wherein the coil 25 is enclosed by plastic.

It can be seen that the coil 25 is electrically connected to an electric wire 26. Hereby, electric power generated by induction can be conducted through the wire 26.

### REFERENCE NUMBERS

1— power station
2— turbine
3— generator
4— transmission shaft
5— rotor
6— axle
7— axle flange
8— support
9— base
10— drum
11— blade
11A—first end of blade 11
11B—second end of blade 11
11C—outwardly directed edge of blade 11
12— slot for blade 11 in drum 10
13— slot in rotational lateral flange 15
14A—first rotational lateral flange
14B—second rotational lateral flange
15— stationary end flange
16— blade guide
16A—first part of blade guide 16
16B—second part of blade guide 16
17— projection of blade 11 into blade guide 16
18— water deflector
19A—water in flow at height of extended blades 11
19B—upwards deflected bottom water
19C—total water through turbine 2
20— direction of rotation of rotor 5
21— seabed
22— indication line for circular path in second guide part 16B
23— longitudinal direction of blade 11
24— permanent magnet
25— coil
26— electric wire

1-16. (canceled)

17. An underwater power station comprising a turbine, the turbine comprising a base and a rotor that is rotationally supported by the base and configured for being rotationally driven by the force of water flowing through the turbine:
wherein the rotor comprises a drum suspended on a rotation axle:
wherein the rotor comprises a plurality of blades, wherein each of the blades is delimited by an rear edge, an front edge, and two end-edges, one at either end of the blade:
wherein the drum comprises a longitudinal axis and one slot for each one of the blades, wherein each one of the blades is suspended slidingly in such one of the slots and arranged for sliding into this slot during a first part of revolution of the rotor and out of this slot during a second part of revolution of the rotor:
wherein the drum is arranged between two rotational lateral flanges and fixed to the rotational lateral flanges for rotating together:
wherein the rotational lateral flanges extend radially outwards from the drum,
characterised in that the turbine comprises a stationary support arranged adjacent to at least one of the rotational lateral flanges, wherein a plurality of permanent magnets are attached to at least one of the rotational lateral flanges, wherein the permanent magnets are distributed along a first circular path corresponding to a circle having a center coinciding with the longitudinal axis of the drum, wherein a plurality of coils are attached to the support, wherein the coils are distributed along a second circular path of the same size as the first circular path and corresponding to a circle having a center coinciding with the longitudinal axis of the drum, wherein the coils are electrically connected to wires arranged to conduct electric current generated by induction upon rotation of the rotor.

18. The underwater power station according to claim 1, wherein a plurality of permanent magnets is attached to both rotational lateral flanges, wherein the permanent magnets are distributed along a circular path corresponding to a circle having a center coinciding with the longitudinal axis of the drum, wherein a plurality of coils are attached to the supports adjacent to each of the rotational lateral flanges (14A, 14B).

19. The underwater power station according to claim 1, wherein the permanent magnets are integrated in rotational lateral flanges made of plastic, wherein the permanent magnets are enclosed by plastic.

20. The underwater power station according to claim 1, wherein the coils are integrated in a support made of plastic, wherein the coils are enclosed by plastic.

21. The underwater power station according to claim 1, wherein the permanent magnets and the coils have the same cross-sectional area.

22. The underwater power station according to claim 1, wherein each of the two end flanges comprises a plurality of radial grooves, of which each one is aligned with only one of the slots and extends radially outward from the corresponding slot: wherein each pair of end-edges of each one of the blades (is suspended slidingly in a corresponding pair of parallel radial grooves for being supported in the grooves and stabilized by the grooves in both rotational lateral flanges when moving radially outside the slot.

23. The underwater power station according to claim 22, wherein the rotor is configured for moving the blade only partially out of the slot so that the rear edge of the blade remains inside the slot for being stabilized by the slot in the drum when the blade extends outwards from the slot.

24. The underwater power station according to claim 22, wherein the turbine comprises two end flanges arranged stationary to the base at opposite ends of the drum; wherein each of the stationary end flanges comprises a closed-curved blade guide, the blade guide extending circumferential around the axle, and wherein a connection member of each of the blades is movably connect-ed in order for the connection member to be guided along the blade guide during rotation of the rotor, wherein the blade guide is closer to the axle in a first part of the blade guide than in a second part of the blade guide for, periodically during each revolution of the rotor, retracting the connection member together with the corresponding blade towards the axle for moving the blade into the slot of the drum, and subsequently moving the connection member together with the corresponding blade away from the axle for moving the blade out of the slot of the drum.

25. The underwater power station according to claim 24, wherein the blade guide has a first radius of curvature at a first location where the blade guide is closest to the axle and a second radius of curvature at a second location where the blade guide is farthest from the axle, wherein the first radius of curvature is smaller than the second radius of curvature.

26. The underwater power station according to claim 25, wherein the blade guide at the first location follows a circular shape over an angle (A) of 70-120 degrees, and wherein the blade guide at the second location follows a circular shape over an angle (B+C) of at least 180 degrees.

27. The underwater power station according to claim 24, wherein the blade guide is provided not closer to the axle than a minimum distance D, wherein D is in a range of 10-50% of a height H of the blade, when measured along the blade in radial direction.

28. The underwater power station according to claim 27, wherein the connection member is provided at a distance d from the rear edge (of the blade, wherein d is in a range of 50-96% of D, and wherein the rotor is configured for moving the connection member radially to a location outside the drum when the corresponding blade is moved maximum out of the slot while the rear edge of the blade remains in the slot of the drum.

29. The underwater power station according to claim 24, wherein the blade guide is provided as a groove or aperture in the end flange.

30. The underwater power station according to claim 29, wherein the connection member (is a projection extending from the end-edge of the blade into the blade guide, and wherein the projection is arranged for sliding inside the blade guide.
